(19) United States
(12) Patent Application Publication
(10) Pub. No.: US 2019/0381903 A1
(43) Pub. Date: Dec. 19, 2019

(54) METHOD OF PROVIDING VEHICLE CHARGING SERVICE

(71) Applicant: LG ELECTRONICS INC., Seoul (KR)

(72) Inventors: Sangmi SHIN, Seoul (KR); Jin SEO, Seoul (KR)

(73) Assignee: LG ELECTRONICS INC., Seoul (KR)

(21) Appl. No.: 16/555,837

(22) Filed: Aug. 29, 2019

(30) Foreign Application Priority Data
Aug. 8, 2019 (KR) 10-2019-0096952

(51) Int. Cl. B60L 53/12; B60L 58/12; B60L 53/66; G05D 1/00; B60L 15/20

(52) U.S. Cl. CPC B60L 53/12; B60L 58/12; B60L 53/665; G06Q 20/14; B60L 15/20; B60L 2240/12; G05D 2201/0213; G05D 1/0088

(57) ABSTRACT

Disclosed herein is a method of providing a vehicle charging service, which includes receiving an entry request signal for entering a charging lane from a vehicle which is driving in a general lane, and transmitting an entry permission signal to the vehicle on the basis of vehicle information of the vehicle and congestion in the charging lane. The vehicle to which the present disclosure is applied may be associated with any artificial intelligence module, a drone, an unmanned aerial vehicle, a robot, an augmented reality (AR) module, a virtual reality (VR) module, a 5^{th} generation (5G) mobile communication device, and the like.

### CROSS-REFERENCE TO RELATED APPLICATION

The present disclosure claims priority to and the benefit of Korean Patent Application No. 10-2019-0096952 filed on Aug. 8, 2019, the disclosure of which is incorporated herein by reference in its entirety.

### BACKGROUND

### 1. Technical Field

The present disclosure relates to a method of providing a charging service to an electric vehicle which is driving in a charging lane or a general lane.

### 2. Related Art

Recently, there is a tendency in which electronic vehicles have been commercialized, and charging stations for charging batteries in electric vehicles have been installed in places.

However, when compared with the number of gas stations for internal combustion engine vehicles, the number of charging stations for electric vehicles is far from enough, and thus the lack of charging stations is causing a slowdown of the speed of commercialization of the electric vehicles.

Further, even when a driver goes to a charging station to charge an electric vehicle, a charging time is very long, and thus the slow charging time is also causing the slowdown of the speed of commercialization of electric vehicles.

In order to solve the above problems, the development of technology for charging an electric vehicle, which is driving on a road, by embedding a wireless charging device in the road and using an electromagnetic induction phenomenon is being started.

However, even though such a technology is applied, since the astronomical amount of money goes into embedding of wireless charging devices in all roads, it is expected that the wireless charging devices will be embedded only in specific areas and specific lanes.

In this case, on a road of two or more lanes, a lane in which a wireless charging device is embedded and the existing lane may coexist, and electric vehicles and general vehicles may be complicatedly mixed to drive together. When such a situation arrives, there may be an indispensable need for a method of providing an efficient charging service to the electric vehicles and, simultaneously, efficiently managing the electric vehicles and the general vehicles which are driving by being mixed in the two or more lanes.

### SUMMARY

Various embodiments are directed to providing a charging service to an electric vehicle which is driving in a charging lane or a general lane.

Also, various embodiments are directed to guiding lane changes of an electric vehicle and a general vehicle according to a road condition.

Objectives of the present disclosure are not limited to the above-described objectives, and other objectives and advantages of the present disclosure, which are not mentioned, can be understood by the following description and also will be apparently understood through embodiments of the present disclosure. It is also to be easily understood that the objectives and advantages of the present disclosure may be realized and attained by means and a combination thereof described in the appended claims.

In an embodiment, a method of providing a vehicle charging service may include receiving an entry request signal for entering a charging lane from a vehicle which is driving in a general lane, and transmitting an entry permission signal to the vehicle on the basis of at least one of vehicle information of the vehicle and congestion in the charging lane.

In addition to effects which will be described below, specific effects of the present invention will be described together with the following detailed description for practicing the present disclosure.

### BRIEF DESCRIPTION OF THE DRAWINGS

FIG. 1 is a diagram illustrating a vehicle charging system according to one embodiment of the present disclosure.

FIG. 2 is a schematic diagram illustrating a data communication process between a vehicle and a server which are illustrated in FIG. 1.

FIG. 3 is a diagram illustrating an example of an application communication process between a vehicle and a server in a 5th generation (5G) communication system.

FIGS. 4 to 7 are diagrams illustrating an example of an operation process of a vehicle using 5G communication.

FIG. 8 is a diagram for describing a process of charging a vehicle which is driving in a charging lane.

FIG. 9 is a flowchart illustrating a method of providing a charging service, which is performed in the server illustrated in FIG. 1, according to one embodiment of the present disclosure.

FIG. 10 is a flowchart illustrating a process of determining whether to enter a charging lane according to the number of vehicles located in the charging lane.

FIG. 11 is a flowchart illustrating a process of determining whether to enter a charging lane according to an average speed of a plurality of vehicles located in the charging lane.

FIG. 12 is a diagram illustrating a charging area which is divided by a charging start point and a charging end point.

FIG. 13 is a flowchart illustrating a process of allowing a vehicle to exit from a charging lane by comparing a target charging level with a battery power level.

FIG. 14 is a diagram illustrating a vehicle which is driving from a general lane to an available entry point of a charging lane.

FIG. 15 is a diagram illustrating a state in which a distance between a plurality of vehicles, which are driving in a charging lane, is adjusted.

FIGS. 16 and 17 are diagrams for describing a process of allowing a general vehicle and an electric vehicle, which are driving in a general lane, to enter a charging lane.

FIGS. 18 and 19 are diagrams for describing a process of allowing a general vehicle and an electric vehicle, which are driving in a charging lane, to exit from the charging lane.

### DETAILED DESCRIPTION

The above and other objectives, features, and advantages of the present disclosure will be described in detail with reference to the accompanying drawings, and therefore, the technical spirit of the present disclosure can be easily implemented by those skilled in the art. Also, in the following description of the present disclosure, if a detailed description of the known related art is determined to obscure the gist of the present disclosure, the detailed description thereof will be omitted. Hereinafter, preferred embodiments according to the present disclosure will be described in detail with reference to the accompanying drawings. In the drawings, the same reference numeral refers to the same or similar component.

In the following description, any configuration being disposed “above (or below)” or “on (or under)” of a component may mean that not only any configuration may be disposed in contact with an upper surface (or lower surface) of the component, but also another component may be interposed between the component and any configuration disposed on (or under) the component.

The present disclosure relates to a method of providing a charging service to an electric vehicle which is driving in a charging lane or a general lane.

Hereinafter, a vehicle charging system and a method of providing a vehicle charging service, which is performed by a server in a vehicle charging system, according to one embodiment of the present disclosure will be described in detail with reference to the accompanying drawings.

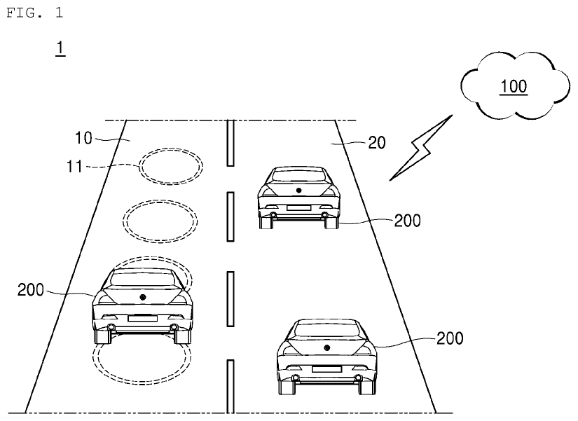

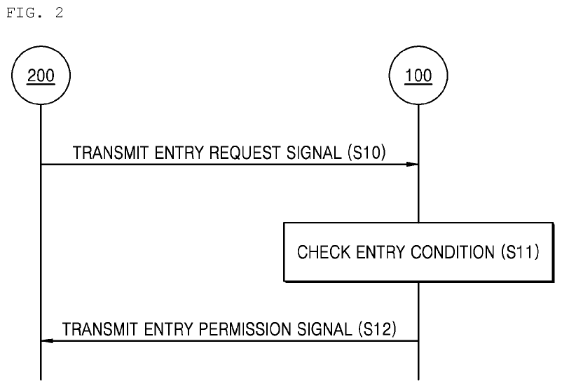

FIG. 1 is a diagram illustrating a vehicle charging system according to one embodiment of the present disclosure, and FIG. 2 is a schematic diagram illustrating a data communication process between a vehicle and a server which are illustrated in FIG. 1.

Referring to FIG. 1, a vehicle charging system 1 according to one embodiment of the present disclosure may include a server 100 and a plurality of vehicles 200 which are driving in a charging lane 10 or a general lane 20. The charging lane 10 may be defined as a lane in which a charging operation is performed on an electric vehicle 200, and the general lane 20 may be defined as a lane in which no charging operation is performed on any vehicle 200. Specifically, the charging lane 10 will be described in detail below.

Referring to FIG. 2, the vehicle 200 which is driving in the general lane 20 may transmit an entry request signal to the server 100 (S10), and the server 100 may check an entry condition of the vehicle 200 (S11) and then transmit an entry permission signal to the vehicle 200 (S12). The vehicle 200 may receive the entry permission signal and then enter the charging lane 10 from the general lane 20.

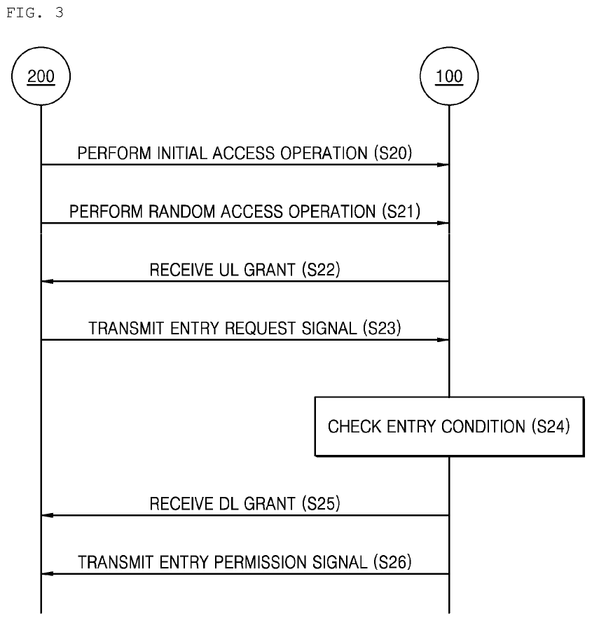

To this end, the vehicle 200 and the server 100 may perform data communication through any wireless communication method which is used in the art. Specifically, the vehicle 200 and the server 100 of the present disclosure may perform data communication in a 5th generation (5G) network. Hereinafter, a data communication method through the 5G network will be described in detail with reference to FIGS. 3 to 7.

FIG. 3 is a diagram illustrating an example of an application communication process between a vehicle and a server in a 5G communication system.

The vehicle 200 may perform an initial access operation with the server 100 (S20).

The initial access operation may include an operation of performing a cell search for acquiring a downlink (DL) operation and an operation of acquiring system information.

Further, the vehicle 200 may perform a random access operation with the server 100 (S21).

The random access operation may include an operation of transmitting a preamble for acquiring an uplink (UL) synchronization or transmitting UL data and an operation of receiving a random access response.

Further, the server 100 may transmit a UL grant for scheduling transmission of the entry request signal to the vehicle 200 (S22).

Reception of the UL grant may include an operation of receiving time/frequency resource scheduling for transmitting UL data to the server 100.

Further, the vehicle 200 may transmit an entry request signal to the server 100 on the basis of the UL grant (S23).

Further, the server 100 may perform an operation of checking an entry condition for transmitting an entry permission signal on the basis of the entry request signal (S24).

Further, the vehicle 200 may receive a DL grant through a physical DL control channel (PDCCH) so as to receive the entry permission signal from the server 100 (S25).

Further, the server 100 may transmit the entry permission signal to the vehicle 200 on the basis of the DL grant (S26).

Meanwhile, in FIG. 3, an example, in which the initial access operation and/or the random access operation and the operation of receiving the DL grant between the vehicle 200 and 5G communication are combined, has been described through operation S20 to S26, but the present disclosure is not limited thereto.

For example, the initial access operation and/or the random access operation may be performed through the operations S20, S22, S23, and S24. Alternatively, for example, the initial access operation and/or the random access operation may be performed through the operations S21, S22, S23, S24, and S26.

Further, in FIG. 3, an operation of the vehicle 200 has been illustratively described through the operations S20 to S26, but the present disclosure is not limited thereto.

For example, the operation of the vehicle 200 may be performed by selectively combining the operations S20, S21, S22, and S25 with the operations S23 and S26. Further, for example, the operation of the vehicle 200 may be constituted of the operations S21, S22, S23, and S26. Alternatively, for example, the operation of the vehicle 200 may be constituted by the operations S20, S21, S23, and S26. Also alternatively, for example, the operation of the vehicle 200 may be constituted by the operations S22, S23, S25, and S26.

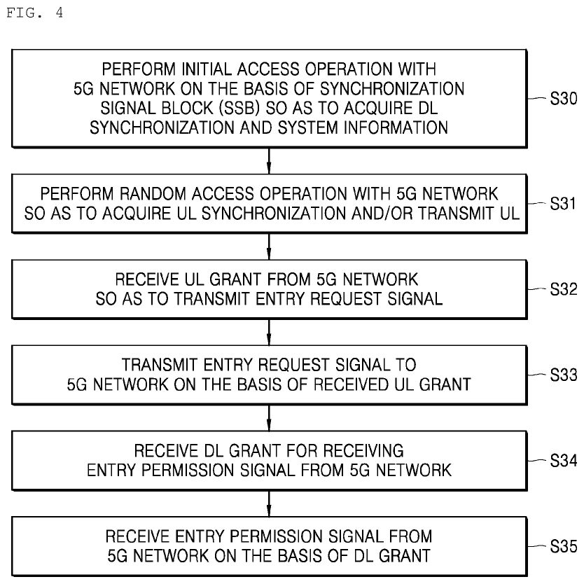

FIGS. 4 to 7 are diagrams illustrating an example of an operation process of a vehicle using 5G communication.

Referring to FIG. 4 first, the vehicle 200 may perform an initial access operation with the server 100 on the basis of a synchronization signal block (SSB) so as to acquire DL synchronization and system information (S30).

Further, the vehicle 200 may perform a random access operation with the server 100 so as to acquire UL synchronization and/or transmit a UL (S31).

Further, the vehicle 200 may receive a UL grant from the server 100 so as to transmit an entry request signal thereto (S32).

Further, the vehicle 200 may transmit the entry request signal to the server 100 on the basis of the UL grant (S33).

Further, the vehicle 200 may receive the DL grant for receiving an entry permission signal from the server 100 (S34).

Further, the vehicle 200 may receive the entry permission signal from the server 100 on the basis of the DL grant (S35).

A beam management (BM) operation may be added to the operation S30, a beam failure recovery operation in association with physical random access channel (PRACH) transmission may be added to operation S31, an operation of adding a quasi-colocation (QCL) relationship in association with a beam reception direction of the PDCCH including the UL grant may be added to the operation S32, and an operation of adding a QCL relationship in association with a beam transmission direction of a physical UL control channel (PUCCH)/physical UL shared channel (PUSCH) including the entry request signal may be added to the operation S33. Further, an operation of adding the QCL relationship in association with the beam reception direction of the PDCCH including the DL grant may be added to the operation S34.

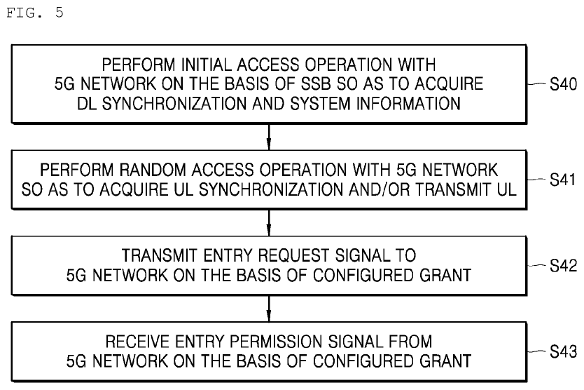

Referring to FIG. 5, the vehicle 200 may perform the initial access operation with the server 100 on the basis of the SSB so as to acquire the DL synchronization and the system information (S40).

Further, the vehicle 200 may perform the random access operation with the server 100 so as to acquire the UL synchronization and/or transmit the UL (S41).

Further, the vehicle 200 may transmit the entry request signal to the server 100 on the basis of a configured grant (S42). In other words, instead of receiving the UL grant from the server 100, the vehicle 200 may transmit the entry request signal to the server 100 on the basis of the configured grant.

Further, the vehicle 200 may receive the entry permission signal from the server 100 on the basis of the configured grant (S43).

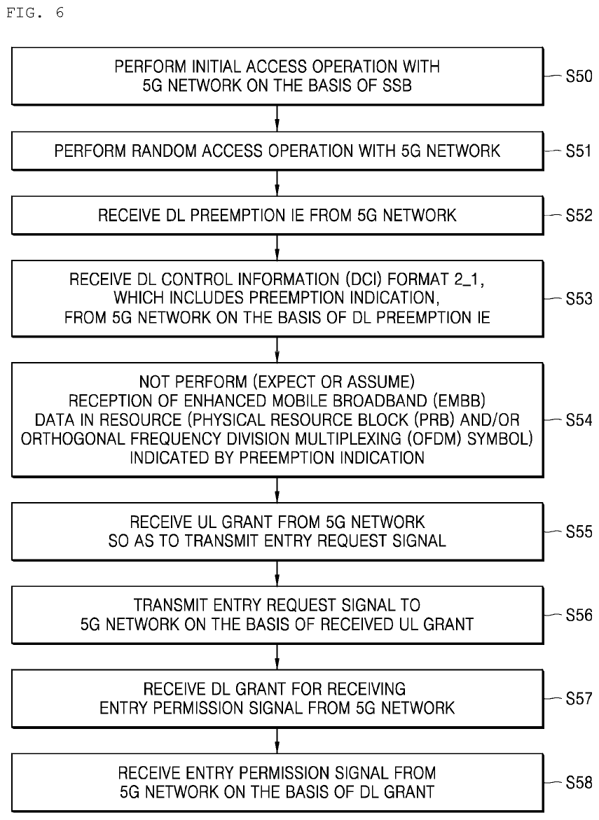

Referring to FIG. 6, the vehicle 200 may perform the initial access operation with the server 100 on the basis of the SSB so as to acquire the DL synchronization and the system information (S50).

Further, the vehicle 200 may perform the random access operation with the server 100 so as to acquire the UL synchronization and/or transmit the UL (S51).

Further, the vehicle 200 may receive a DL preemption IE from the server 100 (S52).

Further, the vehicle 200 may receive a DL control information (DCI) format 2_1, which includes a preemption indication, from the server 100 on the basis of the DL preemption IE (S53).

Further, the vehicle 200 may not perform (expect or assume) reception of enhanced mobile broadband (eMBB) data in a resource (a physical resource block (PRB) and/or an orthogonal frequency division multiplexing (OFDM) symbol) indicated by a preemption indication (S54).

Further, the vehicle 200 may receive a UL grant from the server 100 so as to transmit an entry request signal thereto (S55).

Further, the vehicle 200 may transmit the entry request signal to the server 100 on the basis of the UL grant (S56).

Further, the vehicle 200 may receive the DL grant for receiving an entry permission signal from the server 100 (S57).

Further, the vehicle 200 may receive the entry permission signal from the server 100 on the basis of the DL grant (S58).

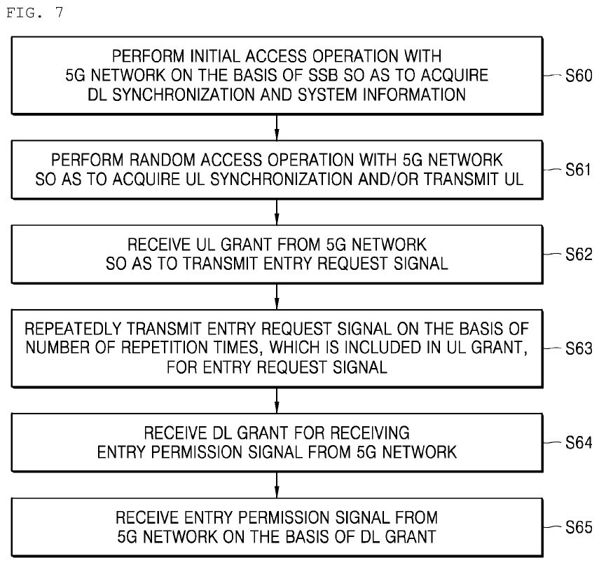

Referring to FIG. 7, the vehicle 200 may perform the initial access operation with the server 100 on the basis of the SSB so as to acquire the DL synchronization and the system information (S60).

Further, the vehicle 200 may perform the random access operation with the server 100 so as to acquire the UL synchronization and/or transmit the UL (S61).

Further, the vehicle 200 may receive a UL grant from the server 100 so as to transmit an entry request signal thereto (S62).

The UL grant may include information on the number of repetition times with respect to the transmission of the entry request signal, and the entry request signal may be repeatedly transmitted on the basis of the information on the number of repetition times (S63).

Further, the vehicle 200 may transmit the entry request signal to the server 100 on the basis of the UL grant.

Further, the repeated transmission of the entry request signal may be performed through frequency hopping, transmission of a first entry request signal may be performed in a first frequency resource, and transmission of a second entry request signal may be performed in a second frequency resource.

The entry request signal may be transmitted through a narrowband of 6 resource blocks (RBs) or 1RB.

Further, the vehicle 200 may receive the DL grant for receiving an entry permission signal from the server 100 (S64).

Further, the vehicle 200 may receive the entry permission signal from the server 100 on the basis of the DL grant (S65).

In FIGS. 3 to 7, the data communication between the vehicle 200 and the server 100 has been described as an example of the transmission and the reception of the entry request signal and the entry permission signal. However, the above-described communication method may be applied to any signal which is transmitted and received between the server 100 and the vehicle 200.

The above-described 5G communication technology may be supplemented to embody or clarify the data communication method of the vehicle 200 described herein. However, as described above, the data communication method of the vehicle 200 is not limited thereto, and the vehicle 200 may perform data communication through various methods which are used in the art.

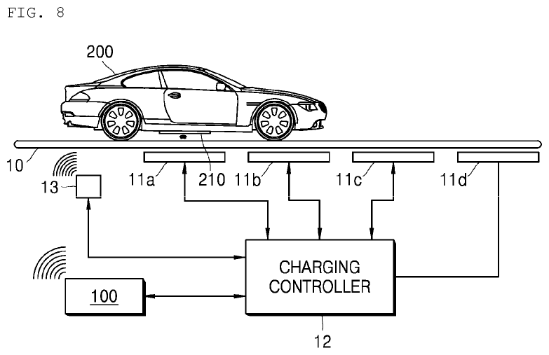

Hereinafter, the method of providing a vehicle charging service, which is performed in the server 100 illustrated in FIG. 1, will be described in detail with reference to FIGS. 8 to 19.

FIG. 8 is a diagram for describing a process of charging a vehicle which is driving in a charging lane.

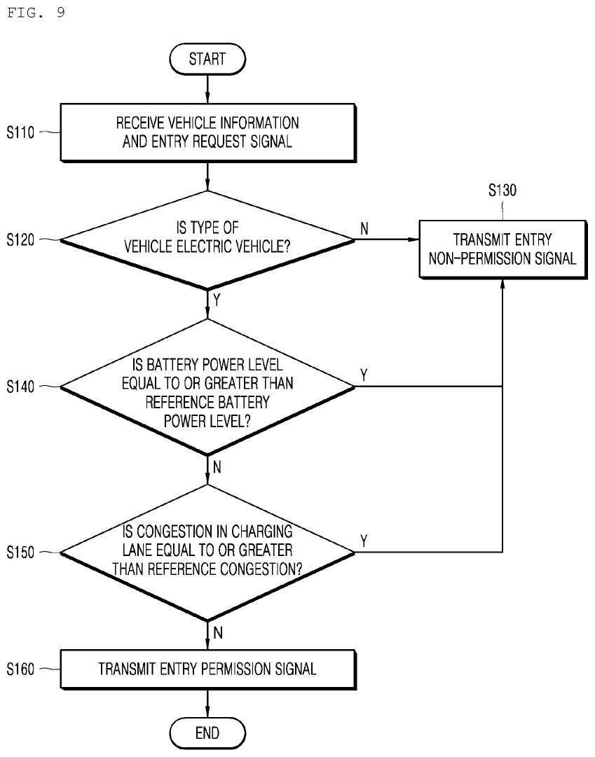

FIG. 9 is a flowchart illustrating a method of providing a charging service, which is performed in the server illustrated in FIG. 1, according to one embodiment of the present disclosure.

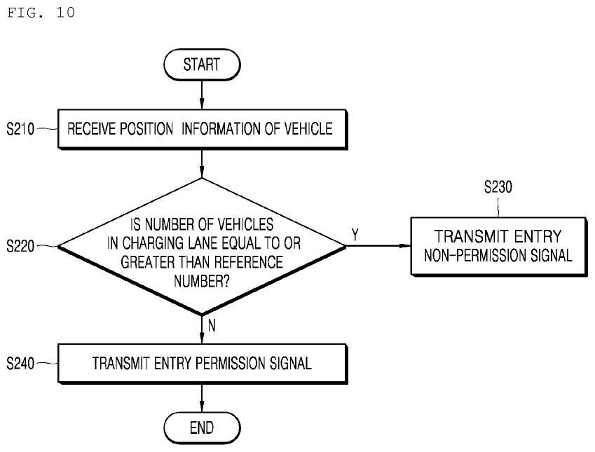

FIG. 10 is a flowchart illustrating a process of determining whether to enter a charging lane according to the number of vehicles located in the charging lane, and

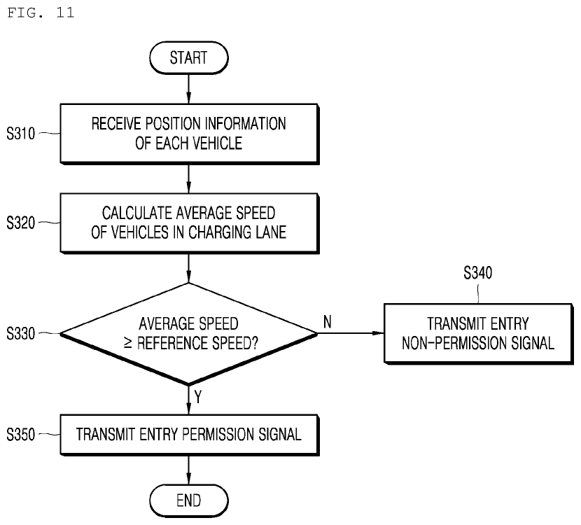

FIG. 11 is a flowchart illustrating a process of determining whether to enter a charging lane according to an average speed of a plurality of vehicles located in the charging lane.

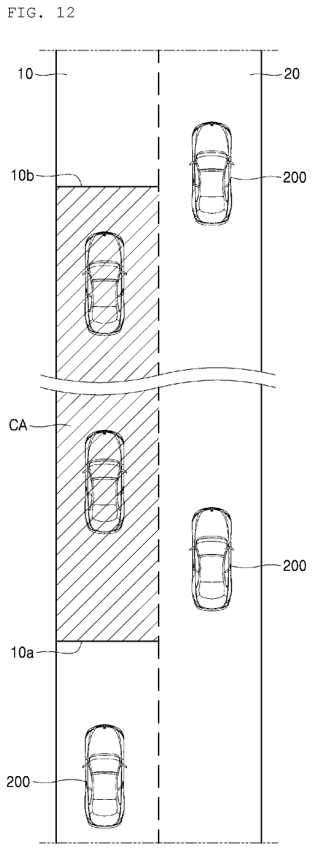

FIG. 12 is a diagram illustrating a charging area which is divided by a charging start point and a charging end point.

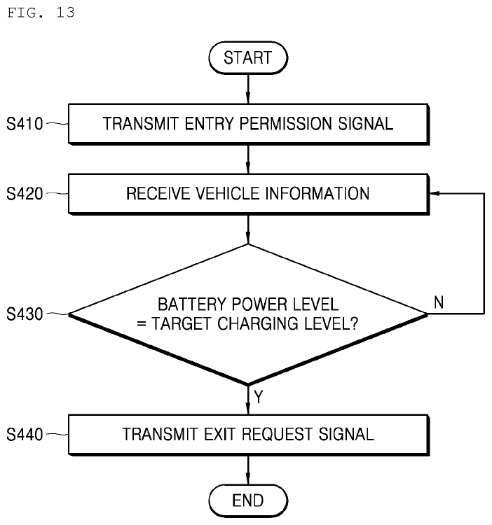

FIG. 13 is a flowchart illustrating a process of allowing a vehicle to exit from a charging lane by comparing a target charging level with a battery power level.

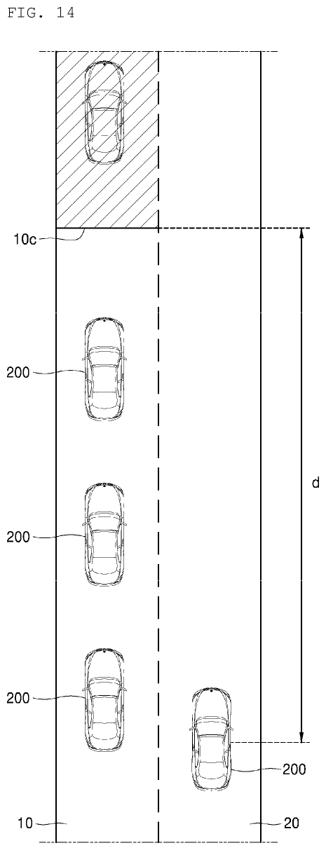

FIG. 14 is a diagram illustrating a vehicle which is driving from a general lane to an available entry point of a charging lane.

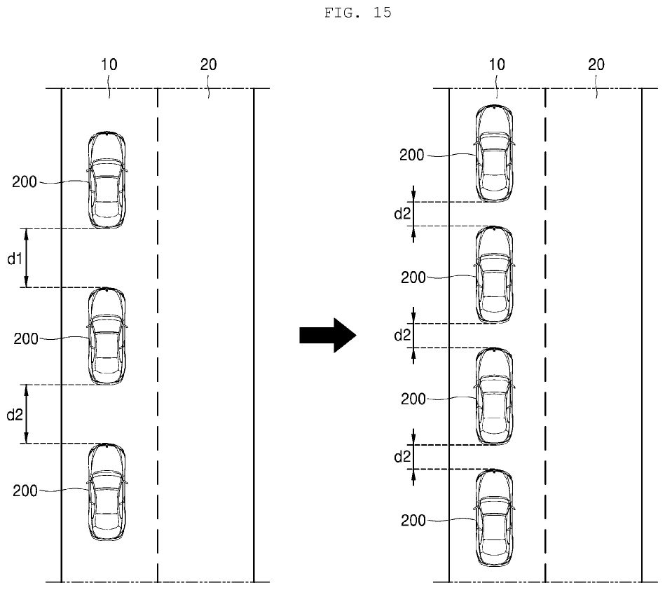

FIG. 15 is a diagram illustrating a state in which a distance between a plurality of vehicles, which are driving in a charging lane, is adjusted.

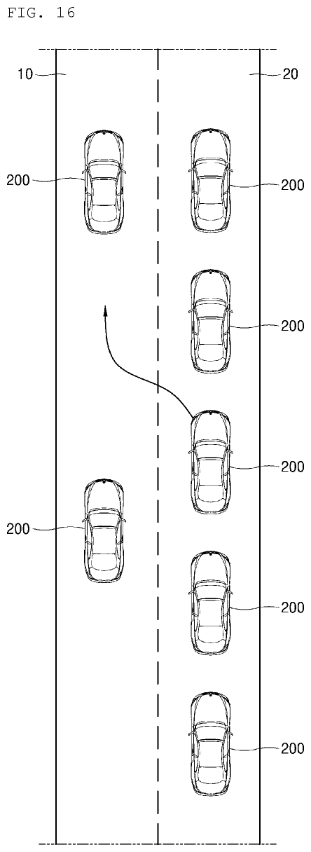

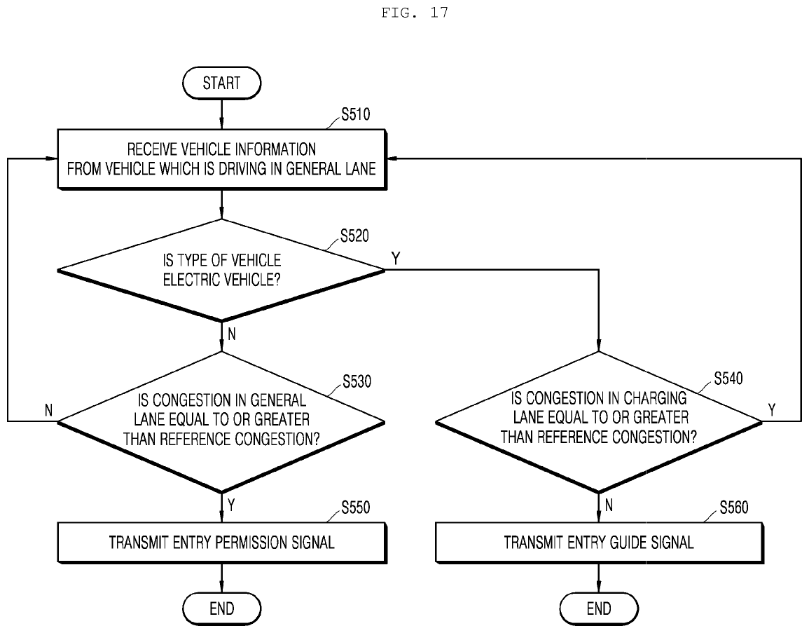

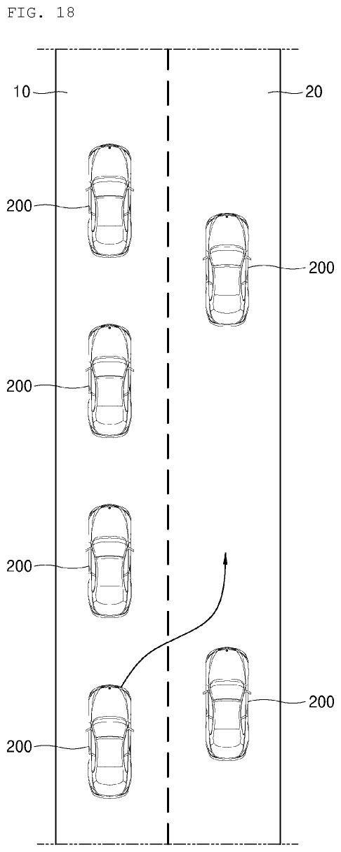

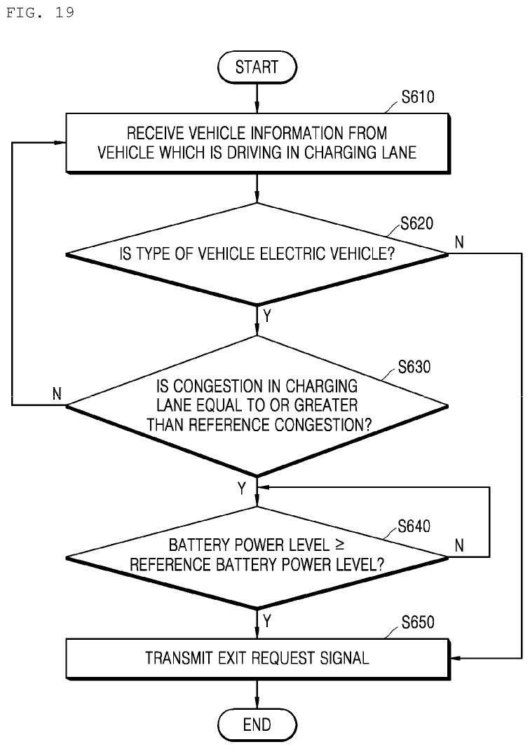

FIGS. 16 and 17 are diagrams for describing a process of allowing a general vehicle and an electric vehicle, which are driving in a general lane, to enter a charging lane. Further, FIGS. 18 and 19 are diagrams for describing a process of allowing a general vehicle and an electric vehicle, which are driving in a charging lane, to exit from the charging lane.

As described above, the server 100 may perform the method of providing a vehicle charging service through data communication with the plurality of vehicles 200 which are driving in the charging lane 10 or the general lane 20. The server 100 may be operated by a transport company which manages the vehicles 200, by a local government and a country which manage roads, by a carrier which provides a network between the vehicles 200, or by a manufacturer of a wireless charging device, which will be described below, provided in the charging lane 10.

The server 100 may be implemented by including a physical element which includes at least one among application specific integrated circuits (ASICs), digital signal processors (DSPs), digital signal processing devices (DSPDs), programmable logic devices (PLDs), field programmable gate arrays (FPGAs), controllers, micro-controllers, and microprocessors.

Meanwhile, in the present disclosure, the vehicle 200 may be a vehicle which is driven according to a user's manipulation or a vehicle which is capable of performing autonomous driving to a destination without user's intervention. The vehicle 200 may be implemented as an internal combustion engine vehicle which is provided with an engine as a power source, a hybrid vehicle which is provided with an engine and an electric motor as power sources, an electric vehicle which is provided with an electric motor as a power source, or a hydrogen fuel cell electric vehicle which is provided with a fuel cell as a power source.

Further, the vehicle 200 to which the present disclosure is applied may be associated with any artificial intelligence module, a drone, an unmanned aerial vehicle, a robot, an augmented reality (AR) module, a virtual reality (VR) module, a 5G mobile communication device, and the like.

Hereinafter, the vehicles 200 will be described by distinguishing a general vehicle 200 from an electric vehicle 200 which includes an internal battery and is capable of charging the internal battery in a wireless manner in the charging lane 10.

First, lanes in which the vehicles 200 are driving will be described with reference to FIGS. 1 and 8.

Referring to FIG. 1, the vehicles 200 performing data communication with the server 100 may be driving in the charging lane 10 or the general lane 20. The general lane 20 may be a road which is divided by a lane to guide the driving of the vehicles 200, and the charging lane 10 may be a road which is capable of performing a charging operation on an electric vehicle 200 in addition to the function of the above-described general lane 20.

To this end, as illustrated in FIGS. 1 and 8, a wireless charging device may be provided in the charging lane 10. More specifically, the wireless charging device may include a plurality of power transmission coils 11 which are disposed parallel to the charging lane 10 in a driving direction of the vehicle, a charging controller 12 for controlling a current and a voltage which are applied to each of the plurality of power transmission coils 11, and a position detection sensor 13 for detecting a position of the vehicle 200.

In particular, the wireless charging device illustrated in FIG. 8 is according to one embodiment, components of the wireless charging device are not limited to the embodiment illustrated in FIG. 8, and some components may be added, changed, or deleted as necessary.

Meanwhile, an electric vehicle 200 may include a power reception coil 210 so as to receive power which is supplied through an electromagnetic induction phenomenon. For example, the electric vehicle 200 may include the power reception coil 210, which is disposed parallel to the power transmission coil 11, at a lower portion of a vehicle body.

The charging controller 12 may apply a current to the power transmission coils 11 provided in the charging lane 10. In this case, magnetic fields may be generated in the power transmission coils 11, and the generated magnetic fields may induce a current in the power reception coil 210 which is provided in the electric vehicle 200. The current induced in the power reception coil 210 may charge the internal battery of the electric vehicle 200.

For example, as illustrated in FIG. 8, when the vehicle 200 is located, among first to fourth power transmission coils 11a, 11b, 11c, and 11d, on the first and second power transmission coils 11 a and 11b, the charging controller 12 may apply a current to only the first and second power transmission coils 11a and 11b. Accordingly, magnetic fields may be generated in the first and second power transmission coils 11a and 11b, and the generated magnetic fields may induce a current in the power reception coil 210 which is provided at the lower portion of the electric vehicle 200. The power reception coil 210 may be electrically connected to the internal battery of the electric vehicle 200, and the internal battery may be charged by the current which is induced in the power reception coil 210.

The charging controller 12 may identify a position of the electric vehicle 200 so as to selectively apply a current to some of the power transmission coils 11.

For example, the charging controller 12 may identify the position of the electric vehicle 200 through the position detection sensor 13. The position detection sensor 13 may identify the position of the electric vehicle 200 through any physical and electrical method. The charging controller 12 may identify the position of the electric vehicle 200 on the basis of information detected by the position detection sensor 13 and may selectively apply a current to the power transmission coil 11 at the lower portion of the electric vehicle 200.

Alternatively, the charging controller 12 may identify the location of the electric vehicle 200 by communicating with the server 100. The server 100 may receive location information of the electric vehicle 200 from a global positioning system (GPS) module in the electric vehicle 200 and transmit the received location information to the charging controller 12. The charging controller 12 may identify the position of the electric vehicle 200 on the basis of the location information received from the server 100 and may selectively apply a current to the power transmission coil 11 at the lower portion of the electric vehicle 200.

The present disclosure relates to a method of providing a charging service to the electric vehicle 200 while adjusting congestion in a lane, when the electric vehicle 200 and the general vehicle 200 are driving in the above-described charging lane 10 or general lane 20.

Hereinafter, the method of providing a vehicle charging service will be described in detail with reference to FIGS. 9 to 19.

The server 100 may receive an entry request signal for entering the charging lane 10 from the vehicle 200 which is driving in the general lane 20. In other words, the server 100 may receive an entry request signal from the general vehicle 200 or the electric vehicle 200, which is driving in the general lane 20. It has been described above that the entry request signal may be received through a 5G network, and thus a detailed description thereof will be omitted herein.

When the entry request signal is received, the server 100 may transmit an entry permission signal to the vehicle 200 on the basis of at least one among vehicle information on the vehicle 200 and congestion in the charging lane 10.

The server 100 may receive vehicle information in real time from all vehicles 200 which are driving in the general lane 20 and the charging lane 10. The vehicle information may include various information on the vehicle 200. For example, the vehicle information may include type information indicating a type of the vehicle 200, state information indicating a state of the vehicle 200, position information indicating a position of the vehicle 200, speed information indicating a speed of the vehicle 200, and the like. Further, when the vehicle 200 is the electric vehicle 200, the vehicle information may include battery information indicating a state of a battery, charging state information indicating whether the power reception coil 210 is activated, and the like. In addition to the above information, the vehicle information may include various information on the vehicle 200.

First, a process of transmitting, by the server 100, the entry permission signal to the vehicle 200 on the basis of the vehicle information on the vehicle 200 will be described. Hereinafter, the vehicle 200 which transmits the entry request signal to the server 100 will be described as a target vehicle 200.

The server 100 may identify a type of the target vehicle 200 on the basis of the above-described vehicle information, and, when the identified type of the target vehicle 200 is an electric type, the server 100 may transmit an entry permission signal.

Referring to FIG. 9, the server 100 may receive vehicle information in real time from the target vehicle 200 and may receive an entry request signal from the target vehicle 200 at a specific time point (S110). When the entry request signal is received, the server 100 may determine whether the target vehicle 200 is the general vehicle 200 or the electric vehicle 200 on the basis of the type information which is included in the vehicle information received from the target vehicle 200 (S120).

As described above, since the wireless charging device in the charging lane 10 may supply power to only the electric vehicle 200, when the target vehicle 200 is determined as the electric vehicle 200, the server 100 may transmit the entry permission signal to the target vehicle 200 (S160), and, when the target vehicle 200 is determined as the general vehicle 200, the server 100 may transmit an entry non-permission signal to the target vehicle 200 (S130).

Further, the server 100 may transmit the entry permission signal on the basis of a battery power level included in the vehicle information.

Referring to FIG. 9 again, the server 100 may receive the vehicle information in real time from the target vehicle 200 and may receive the entry request signal from the target vehicle 200 at a specific time point (S110). When the entry request signal is received, the server 100 may identify a battery power level of the target vehicle 200 on the basis of the battery information received from the target vehicle 200 and determine whether the identified battery power level is equal to or greater than a reference battery power level (S140).

When the number of electric vehicles 200 to enter the charging lane 10 is large, in order to prevent a driving failure of an electric vehicle 200 due to battery discharge, the server 100 may allow an electric vehicle 200 having a relatively low battery power level to preferentially enter the charging lane 10.

To this end, when the battery power level of the target vehicle 200 is less than the reference battery power level, the server 100 may transmit the entry permission signal to the target vehicle 200 (S160), and, when the battery power level of the target vehicle 200 is equal to or greater than the reference battery power level, the server 100 may transmit the entry non-permission signal to the target vehicle 200 (S130).

Next, a process of transmitting, by the server 100, the entry permission signal to the vehicle 200 on the basis of congestion in the charging lane 10 will be described.

The congestion in the charging lane 10 may be a predetermined indicator which indicates a degree of congestion in the charging lane 10. For example, the congestion in the charging lane 10 may be defined as a ratio of road traffic to a traffic capacity in the charging lane 10.

When the entry request signal is received from the target vehicle 200 (S110), the server 100 may identify congestion in the charging lane 10 and determine whether the identified congestion in the charging lane 10 is equal to or greater than reference congestion (S150).

When the charging lane 10 is already congested over a predetermined level, since the target vehicle 200 being allowed to enter the charging lane 10 may adversely affect traffic safety, in a situation in which the congestion in the charging lane 10 is relatively low, the server 100 may allow the target vehicle 200 to enter the charging lane 10.

To this end, when the congestion in the charging lane 10 is less than the reference congestion, the server 100 may transmit the entry permission signal to the target vehicle 200 (S160), and, when the congestion in the charging lane 10 is equal to or greater than the reference congestion, the server 100 may transmit the entry non-permission signal to the target vehicle 200 (S130).

Meanwhile, the congestion in the charging lane 10 may be proportional to the number of vehicles 200 which are driving in the charging lane 10. In other words, as the number of vehicles 200 which are driving in the charging lane 10 increases, the congestion in the charging lane 10 may increase.

In consideration of the above description, the server 100 may transmit the entry permission signal on the basis of the number of vehicles 200 which are driving in the charging lane 10.

Referring to FIG. 10, the server 100 may receive position information included in the vehicle information from all the vehicles 200 which are driving in the general lane 20 and the charging lane 10 (S210).

More specifically, all the vehicles 200 may each be provided with a GPS module, and the GPS module may acquire position information on which the GPS module is positioned by analyzing satellite signals which are output from satellites. Since the GPS module is embedded in each of the vehicles 200, the position information acquired by the GPS module may be the position information of each of the vehicles 200.

Each of the vehicles 200 may add the position information acquired by the embedded GPS module to the vehicle information and transmit the vehicle information to the server 100, and the server 100 may receive the position information from each of the vehicles 200.

When the position information is received, the server 100 may compare map information, which is stored in a database in the server 100, with the position information of each of the vehicles 200, thereby identifying a lane in which each of the vehicles 200 is driving. More specifically, the server 100 may compare position information of the charging lane 10 and the general lane 20, which is included in the map information, with the position information of each of the vehicles 200 to determine whether each of the vehicles 200 is driving in the charging lane 10 or the general lane 20.

Through the above-described process, the server 100 may identify the number of the vehicles 200 which are driving in the charging lane 10, and, when the entry request signal is received from the target vehicle 200, the server 100 may determine whether the number of the vehicles 200 which are driving in the charging lane 10 is equal to or greater than a reference number (S220).

When many vehicles 200 are already driving in the charging lane 10, since the target vehicle 200 being allowed to enter the charging lane 10 may adversely affect traffic safety, in a situation in which a relatively small number of the vehicles 200 are driving in the charging lane 10, the server 100 may allow the target vehicle 200 to enter the charging lane 10.

To this end, when the number of the vehicles 200 in the charging lane 10 is less than a reference number, the server 100 may transmit the entry permission signal to the target vehicle 200 (S240), and, when the number of the vehicles 200 in the charging lane 10 is equal to or greater than the reference number, the server 100 may transmit the entry non-permission signal to the target vehicle 200 (S230).

Meanwhile, the congestion in the charging lane 10 may be inversely proportional to a speed of the vehicle 200 which is driving in the charging lane 10. That is, as the congestion in the charging lane 10 increases, the speed of the vehicle 200 which is driving in the charging lane 10 may decrease.

In consideration of the above description, the server 100 may transmit the entry permission signal on the basis of an average speed of the vehicles 200 which are driving in the charging lane 10.

Referring to FIG. 11, as described in operation S210 of FIG. 10, the server 100 may receive the position information of each of the vehicles 200 in real time. When the entry request signal is received from the target vehicle 200 at a specific time point, the server 100 may calculate a current average speed of the vehicles 200 in the charging lane 10 (S320).

More specifically, the server 100 may calculate a speed of each of the vehicles 200 by dividing a position variance of each of the vehicles 200, which is identified in the charging lane 10, by time and calculate the average speed by averaging the calculated speeds of the vehicles 200.

Alternatively, the server 100 may receive the vehicle information including the speed information from each of the vehicles 200 and calculate the average speed of the vehicles 200 in the charging lane 10 on the basis of the received speed information of the vehicles 200.

When the average speed is calculated, the server 100 may determine whether the calculated average speed is equal to or greater than a reference speed (S330).

When the charging lane 10 is congested and thus the average speed of the vehicles 200 in the charging lane 10 is low, since the target vehicle 200 being allowed to enter the charging lane 10 may adversely affect traffic safety, in a situation in which the average speed of the vehicles 200 which are driving in the charging lane 10 is relatively high, the server 100 may allow the target vehicle 200 to enter the charging lane 10.

To this end, when the average speed of the vehicles 200 in the charging lane 10 is equal to or greater than the reference speed, the server 100 may transmit the entry permission signal to the target vehicle 200 (S350), and, when the average speed of the vehicles 200 in the charging lane 10 is less than the reference speed, the server 100 may transmit the entry non-permission signal to the target vehicle 200 (S340).

The above-described process of transmitting the entry permission signal by the server 100 may be performed by independent operations or two or more combined operations.

Alternatively, the server 100 may receive an entry request signal, which includes a charging start point 10a and a charging end point 10b, from the target vehicle 200.

The target vehicle 200 may transmit an entry request signal for entering the charging lane 10 so as to charge the internal battery in only a specific area. To this end, the target vehicle 200 may generate and transmit the entry request signal, which includes the charging start point 10a and the charging end point 10b, to the server 100.

Referring to FIG. 12, the target vehicle 200 may designate a forward specific point as the charging start point 10a and designate a further forward specific point as the charging end point 10b. The target vehicle 200 may transmit the entry request signal, which includes the designated charging start point 10a and the designated charging end point 10b, to the server 100.

The server 100 may transmit the entry permission signal on the basis of congestion in a charging area CA which is divided by the charging start point 10a and the charging end point 10b.

For example, the server 100 may transmit the entry permission signal on the basis of the number of vehicles 200 which are driving between the charging start point 10a and the charging end point 10b. More specifically, the server 100 performs the operations described in FIG. 10 and may compare a reference number with the number of vehicles 200 in the charging area CA of the charging lane 10 to transmit the entry permission signal or the entry non-permission signal to the target vehicle 200.

Alternatively, the server 100 may transmit the entry permission signal on the basis of an average speed of a plurality of vehicles 200 which are driving between the charging start point 10a and the charging end point 10b. More specifically, the server 100 performs the operations described in FIG. 11 and may compare a reference speed with the average speed of the plurality of vehicles 200 in the charging area CA of the charging lane 10 to transmit the entry permission signal or the entry non-permission signal to the target vehicle 200.

The operations illustrated in FIGS. 10 and 11 have been described above, and thus detailed descriptions thereof will be omitted herein.

The target vehicle 200 which receives the entry permission signal may enter the charging lane 10 from the general lane 20 at the charging start point 10a and may exit from the charging lane 10 to the general lane 20 at the charging end point 10b.

Alternatively, the server 100 may receive an entry request signal, which includes a target charging level, from the target vehicle 200.

The target vehicle 200 may transmit the entry request signal for entering the charging lane 10 so as to charge the internal battery with only a predetermined amount. To this end, the target vehicle 200 may generate and transmit the entry request signal, which includes the target charging level, to the server 100. The server 100 may transmit the entry permission signal to the target vehicle 200 through the above-described process, and the target vehicle 200 may enter and drive in the charging lane 10.

Referring to FIG. 13, the server 100 may transmit the entry permission signal to the target vehicle 200 (S410) and then receive vehicle information including battery information from the target vehicle 200 which enters the charging lane 10 (S420).

Subsequently, the server 100 may compare a battery power level of the target vehicle 200, which is identified through the battery information, with the target charging level included in the entry request signal (S430).

As the target vehicle 200 drives in the charging lane 10, the battery power level may gradually increase, and, when the battery power level reaches the target charging level, the server 100 may transmit an exit request signal to the target vehicle 200 (S440). Here, the exit request signal may be a predetermined signal for guiding the target vehicle 200 to exit from the charging lane 10 to the general lane 20. The exit request signal may include a charging completion message which indicates that charging is completed.

Meanwhile, when the entry request signal is received from the target vehicle 200, the server 100 may determine an available entry point on the basis of the congestion in the charging lane 10, and, when the position of the vehicle 200 is within a predetermined distance from the available entry point, the server 100 may transmit the entry permission signal to the target vehicle 200.

More specifically, the server 100 may divide the charging lane 10 into imaginary areas in a driving direction of the vehicle 200 and determine congestion with respect to each of the imaginary areas. The server 100 may determine an imaginary area, of which the determined congestion is less than reference congestion, as the charging area CA and determine a position, at which the imaginary area starts, as the available entry point.

Referring to FIG. 14, the server 100 may determine a section between an arbitrary start point and a forward point at a predetermined distance spaced apart from the arbitrary start point as the imaginary area and determine that congestion in the imaginary area is less than the reference congestion. In this case, the server 100 may determine the imaginary area as the charging area CA and determine a start point, at which the imaginary area starts, as an available entry point 10c.

Subsequently, the server 100 may identify a distance between the position of the target vehicle 200 and the available entry point 10c on the basis of the position information of the target vehicle 200, and, when the identified distance is within a preset distance d, the server 100 may transmit the entry permission signal to the target vehicle 200. In this case, information on the available entry point 10c may be included in the entry permission signal.

Accordingly, the target vehicle 200 may check the available entry point 10c ahead thereof by receiving the entry permission signal from the server 100 and enter the charging lane 10 at the available entry point 10c.

Meanwhile, referring to FIG. 8 again, the wireless charging device may consume a lot of power so as to charge the electric vehicle 200. Accordingly, the server 100 may collect a charging fee for using the charging lane 10 so as to preserve costs according to power consumption.

To this end, the server 100 may determine a charging fee of the charging lane 10 and transmit information on the determined charging fee (hereinafter, referred to as fee information) to the vehicle 200.

More specifically, the server 100 may generate the charge information on the basis of the congestion in the charging lane 10. When the congestion in the charging lane 10 is high, the demand for the use of the charging lane 10 is high so that the charging fee of the charging lane 10 may increase. On the other hand, when the congestion in the charging lane 10 is low, the demand for the use of the charging lane 10 is low so that the charging fee of the charging lane 10 may decrease.

For example, the server 100 may determine a charging fee proportional to the number of vehicles 200 which are driving in the charging lane 10 and generate fee information on the determined charging fee.

More specifically, as the number of vehicles 200 which are driving in the charging lane 10 increases, the server 100 may determine a higher charging fee and, as the number of vehicles 200 which are driving in the charging lane 10 decreases, the server 100 may determine a lower charging fee.

Meanwhile, the charging fee of the charging lane 10 may be determined as the sum of a basic fee and an additional fee. In this case, the server 100 may determine the additional fee in proportion to the number of vehicles 200 which are driving in the charging lane 10. In this case, the base fee is always preserved regardless of the number of vehicles 200 using the charging lane 10 so that a constant profit may be guaranteed in the operation of the charging lane 10.

The identifying of the number of vehicles 200 which are driving in the charging lane 10 has been described with reference to FIG. 10, and thus a further description thereof will be omitted herein.

Alternatively, the server 100 may determine a charging fee in inverse proportion to an average speed of the vehicles 200 which are driving in the charging lane 10 and generate fee information on the determined charging fee.

More specifically, as the average speed of the vehicles 200 which are driving in the charging lane 10 is low, the server 100 may determine a higher charging fee and, as the average speed of the vehicles 200 which are driving in the charging lane 10 is high, the server 100 may determine a lower charging fee.

Similarly, when the charging fee of the charging lane 10 is determined as the sum of the base fee and the additional fee, the server 100 may determine the additional fee in inverse proportion to the average speed of the plurality of vehicles 200 which are driving in the charging lane 10.

The calculating of the average speed of the plurality of vehicles 200 which are driving in the charging lane 10 has been described with reference to FIG. 11, and thus a further description thereof will be omitted herein.

The server 100 may transmit the fee information, which is generated through the above-described process, to the target vehicle 200, and the target vehicle 200 may pay the charging fee which is identified through the fee information. To this end, the fee information may include information on an account for the charging fee to be paid.

Meanwhile, when the average speed of the plurality of vehicles 200 which are driving in the charging lane 10 is less than a preset speed, the server 100 may transmit a vehicle-to-vehicle distance reduction signal to the plurality of vehicles 200. In this case, the plurality of vehicles 200 which are driving in the charging lane 10 may be a plurality of autonomous vehicles 200.

Referring to FIG. 15, the plurality of autonomous vehicles 200 may be driving in the charging lane 10. In this case, each of the autonomous vehicles 200 may drive while maintaining a first distance d1 from adjacent autonomous vehicles 200. The first distance d1 may be predetermined according to a driving algorithm applied to each of the autonomous vehicles 200.

Meanwhile, as an average speed of the plurality of autonomous vehicles 200 which are driving in the charging lane 10 decreases, defensive driving may be facilitated such that a driving risk may be reduced. In consideration of the above description, when the average speed of the plurality of autonomous vehicles 200 which are driving in the charging lane 10 is less than a preset speed, the server 100 may generate a vehicle-to-vehicle distance reduction signal and transmit the vehicle-to-vehicle distance reduction signal to each of the plurality of autonomous vehicles 200.

Each of the plurality of autonomous vehicles 200 may perform autonomous driving according to the vehicle-to-vehicle distance reduction signal to reduce a distance to adjacent vehicles 200. More specifically, as illustrated in FIG. 15, each of the plurality of autonomous vehicles 200, which receives the vehicle-to-vehicle distance reduction signal, may drive while maintaining a second distance d2 that is smaller than the first distance d1, from the adjacent autonomous vehicles 200.

Here, the second distance d2 may be set in proportion to the average speed of the plurality of autonomous vehicles 200 which are driving in the charging lane 10. In other words, as the average speeds of the plurality of autonomous vehicles 200 decrease, the second distance d2 may be set to be smaller, and as the average speeds of the plurality of autonomous vehicles 200 increase, the second distance d2 may be set to be larger.

Thus, the distance between the vehicles 200 which are driving in the charging lane 10 is adjusted such that, as illustrated in FIG. 15, more vehicles 200 may use the charging lane 10 in the same section.

As described above, the present disclosure provides an efficient charging service to the electric vehicle 200 which are driving in the charging lane 10 or the general lane 20 such that not only commercialization of the electric vehicle 200 but also a time schedule for construction of a charging infrastructure for the electric vehicle 200 may be advanced, and charging service for the electric vehicle 200 may create revenue.

Hereinafter, a process of transmitting and receiving a signal to and from a general vehicle 200 and an electric vehicle 200 which are driving in the general lane 20 and a process of transmitting and receiving a signal to and from the general vehicle 200 and the electric vehicle 200 which are driving in the charging lane 10 will be described.

Referring to FIGS. 16 and 17 first, the server 100 may receive vehicle information from a vehicle 200 which is driving in the general lane 20 (S510). When a type of the vehicle 200, which is identified on the basis of the received vehicle information, is the general vehicle 200 and congestion in the general lane 20 is equal to or greater than a reference congestion, the server 100 may transmit an entry permission signal to the vehicle 200.

More specifically, the server 100 may determine whether the type of the vehicle 200 is the electric vehicle 200 on the basis of type information in the vehicle information (S520). As the determination result in operation S520, when the type of the vehicle 200 is the general vehicle 200, the server 100 may determine whether the congestion in the general lane 20 is equal to or greater than the reference congestion (S530). A method of determining the congestion in the general lane 20 may be the same as the above-described method of determining the congestion in the charging lane 10.

As the determination result in operation S530, when the congestion in the general lane 20 is less than the reference congestion, the server 100 may continuously receive the vehicle information from the vehicle 200 which is driving in the general lane 20 (S510). Otherwise, when the congestion in the general lane 20 is equal to or greater than the reference congestion, the server 100 may transmit an entry permission signal to the vehicle 200 (S550).

That is, as described above with reference to FIG. 9, the server 100 may basically transmit the entry permission signal to only the electric vehicle 200 which is driving in the general lane 20. However, when the congestion in the general lane 20 is high, the server 100 may also transmit the entry permission signal to the general vehicle 200 which is driving in the general lane 20.

Meanwhile, when the type of the vehicle 200 which is driving in the general lane 20 is the electric vehicle 200 and the congestion in the charging lane 10 is less than the reference congestion, the server 100 may transmit an entry guide signal to the vehicle 200.

More specifically, as the determination result in operation S520, when the type of the vehicle 200 is the general vehicle 200, the server 100 may determine whether the congestion in the charging lane 10 is equal to or greater than the reference congestion (S540).

As the determination result in operation S540, when the congestion in the charging lane 10 is equal to or greater than the reference congestion, the server 100 may continuously receive the vehicle information from the vehicle 200 which is driving in the general lane 20 (S510). Otherwise, when the congestion in the charging lane 10 is less than the reference congestion, the server 100 may transmit the entry guide signal to the vehicle 200 (S560). Here, the entry guide signal may be a predetermined signal which guides the vehicle 200 to enter the charging lane 10.

That is, as described above with reference to FIG. 9, the server 100 may basically transmit the entry permission signal to the electric vehicle 200 which transmits the entry request signal. However, when the congestion in the charging lane 10 is low, the server 100 may guide an electric vehicle 200, which is driving in the general lane 20 but does not transmit the entry request signal, to enter the charging lane 10.

The operation S540 may also be performed when the congestion in the general lane 20 is equal to or greater than the reference congestion. In other words, when the congestion in the general lane 20 is high while the congestion in the charging lane 10 is low, the server 100 may transmit the entry guide signal to the electric vehicle 200 which is driving in the general lane 20 to allow the electric vehicle 200 to enter the charging lane 10.

Next, referring to FIGS. 18 and 19, the server 100 may receive vehicle information from a vehicle 200 which is driving in the charging lane 10 (S610). When a type of the vehicle 200, which is identified on the basis of the received vehicle information, is the electric vehicle 200 and the congestion in the charging lane 10 is equal to or greater than the reference congestion, the server 100 may transmit an exit request signal to a vehicle 200 of which the battery power level, which is identified on the basis of the vehicle information, is equal to or greater than the reference battery power level.

More specifically, the server 100 may determine whether the type of the vehicle 200 is the electric vehicle 200 on the basis of type information in the vehicle information (S620). As the determination result in operation S620, when the type of the vehicle 200 is the general vehicle 200, the server 100 may transmit the exit request signal to the vehicle 200 (S650). In other words, the server 100 may basically guide the general vehicle 200 which is driving in the charging lane 10 to exit from the charging lane 10.

Otherwise, as the determination result in operation S620, when the type of the vehicle 200 is the electric vehicle 200, the server 100 may determine whether the congestion in the charging lane 10 is equal to or greater than the reference congestion (S630). As the determination result in operation S630, when the congestion in the charging lane 10 is less than the reference congestion, the server 100 may continuously receive the vehicle information from the vehicle 200 which is driving in the charging lane 10.

Otherwise, as the determination result in operation S630, when the congestion in the charging lane 10 is equal to or greater than the reference congestion, the server 100 may identify the battery power level of the vehicle 200 on the basis of battery information included in the vehicle information and continuously determine whether the identified battery power level is equal to or greater than the reference battery power level (S640).

As the determination result in operation S640, when the battery power level is equal to or greater than the reference battery power level, the server 100 may transmit the exit request signal to the vehicle 200 (S650). In other words, when the congestion in the charging lane 10 is high, the server 100 may guide the electric vehicle 200 with a sufficient battery power level to exit from the charging lane 10.

Through the operations of the server 100 described with reference to FIGS. 16 to 19, traffic in the general lane 20 and the charging lane 10 may be adjusted, and traffic congestion in the entire roads may be reduced.

Meanwhile, when the electric vehicle 200 which is driving in the charging lane 10 is not charging the internal battery, the server 100 may transmit a charging guide signal to the electric vehicle 200.

More specifically, the server 100 may receive the vehicle information from the vehicle 200 which is driving in the charging lane 10, identify the type of the vehicle 200 on the basis of the type information included in the vehicle information, and identify a charging state of the vehicle 200 on the basis of charging state information included in the vehicle information. Here, the charging state information may indicate whether the power reception coil 210 is activated, and a charging state may be divided into an inactive state in which the power reception coil 210 is inactivated and an active state in which the power reception coil 210 is activated.

As the identification result of the type and the charging state, when the type of the vehicle 200 is the electric vehicle 200 and the charging state is an inactive state, the server 100 may transmit the charging guide signal to the vehicle 200. Here, the charging guide signal may be a predetermined signal for guiding switching of the charging state.

That is, when the internal battery is not being charged even though the electric vehicle 200 is driving in the charging lane 10, the server 100 may guide the electric vehicle 200 to charge the internal battery. In this case, the vehicle 200 may receive not only the charging guide signal but also the above-described fee information.

As described above, the present disclosure guides lane changes of the electric vehicle 200 and the general vehicle 200 according to a road condition such that, in a situation in which the electric vehicle 200 and the general vehicle 200 are complicatedly mixed to drive together, a charging service for the electric vehicle 200 may be provided and traffic congestion may be lowered.

In accordance with the present disclosure, an efficient charging service is provided to an electric vehicle which is driving in a charging lane or a general lane such that not only commercialization of the electric vehicle but also a time schedule for construction of a charging infrastructure for the electric vehicle can be advanced, and a charging service for the electric vehicle can create revenue.

Further, in accordance with the present disclosure, lane changes of the electric vehicle and a general vehicle are guided according to a road condition such that, in a situation in which the electric vehicle and the general vehicle are complicatedly mixed to drive together, a charging service for the electric vehicle can be provided and traffic congestion can be lowered.

It should be understood that various substitutions, modifications, and alternations can be derived by those skilled in the art without departing from the technical spirit of the present disclosure and the present disclosure is not limited to the above described embodiments and the accompanying drawings.

While various embodiments have been described above, it will be understood to those skilled in the art that the embodiments described are by way of example only. Accordingly, the disclosure described herein should not be limited based on the described embodiments.

What is claimed is:

1. A method of providing a vehicle charging service, comprising:
receiving an entry request signal for entering a charging lane from a vehicle which is driving in a general lane; and
transmitting an entry permission signal to the vehicle on the basis of at least one of vehicle information of the vehicle and congestion in the charging lane.

2. The method of claim 1, wherein the receiving of the entry request signal and the transmitting of the entry permission signal include receiving the entry request signal through a 5^{th} generation (5G) network and transmitting the entry permission signal through the 5G network.

3. The method of claim 1, wherein the transmitting of the entry permission signal to the vehicle on the basis of at least one of the vehicle information of the vehicle and the congestion in the charging lane includes identifying a type of the vehicle on the basis of the vehicle information and, when the identified type is an electric vehicle, transmitting the entry permission signal.

4. The method of claim 1, wherein the transmitting of the entry permission signal to the vehicle on the basis of at least one of the vehicle information of the vehicle and the congestion in the charging lane includes transmitting the entry permission signal on the basis of a battery power level included in the vehicle information.

5. The method of claim 1, wherein the transmitting of the entry permission signal to the vehicle on the basis of at least one of the vehicle information of the vehicle and the congestion in the charging lane includes transmitting the entry permission signal on the basis of the number of vehicles which are driving in the charging lane.

6. The method of claim 1, wherein the transmitting of the entry permission signal to the vehicle on the basis of at least one of the vehicle information of the vehicle and the congestion in the charging lane includes transmitting the entry permission signal on the basis of an average speed of a plurality of vehicles which are driving in the charging lane.

7. The method of claim 1, wherein the receiving of the entry request signal for entering the charging lane from the vehicle which is driving in the general lane includes receiving the entry request signal which includes a charging start point and a charging end point.

8. The method of claim 7, wherein the transmitting of the entry permission signal to the vehicle on the basis of at least one of the vehicle information of the vehicle and the congestion in the charging lane includes transmitting the entry permission signal on the basis of the number of vehicles which are driving between the charging start point and the charging end point.

9. The method of claim 7, wherein the transmitting of the entry permission signal to the vehicle on the basis of at least one of the vehicle information of the vehicle and the congestion in the charging lane includes transmitting the entry permission signal on the basis of an average speed of a plurality of vehicles which are driving between the charging start point and the charging end point.

10. The method of claim 1, wherein the receiving of the entry request signal for entering the charging lane from the vehicle which is driving in the general lane includes receiving the entry request signal which includes a target charging level.

11. The method of claim 10, further comprising:
receiving the vehicle information from the vehicle which enters the charging lane;
comparing a battery power level included in the vehicle information with the target charging level; and
when the battery power level reaches the target charging level, transmitting an exit request signal to the vehicle.

12. The method of claim 1, wherein the transmitting of the entry permission signal to the vehicle on the basis of at least one of the vehicle information of the vehicle and the congestion in the charging lane includes:
determining an available entry point on the basis of the congestion in the charging lane; and
when a position of the vehicle is within a predetermined distance from the available entry point, transmitting the entry permission signal to the vehicle.

13. The method of claim 1, further comprising:
generating fee information on the basis of the congestion in the charging lane; and
transmitting the generated fee information to the vehicle.

14. The method of claim 13, wherein the generating of the fee information on the basis of the congestion in the charging lane includes determining a charging fee proportional to the number of vehicles which are driving in the charging lane and generating the fee information on the determined charging fee.

15. The method of claim 13, wherein the generating of the fee information on the basis of the congestion in the charging lane includes determining a charging fee inversely proportional to an average speed of a plurality of vehicles which are driving in the charging lane and generating the fee information on the determined charging fee.

16. The method of claim 1, further comprising:
when an average speed of the plurality of vehicles which are driving in the charging lane is less than a preset speed, transmitting a vehicle-to-vehicle distance reduction signal to the plurality of vehicles,
wherein each of the plurality of vehicles performs autonomous driving so as to reduce a distance to adjacent vehicles in response to the vehicle-to-vehicle distance reduction signal.

17. The method of claim 1, further comprising:
receiving the vehicle information from the vehicle which is driving in the general lane; and
when a type of the vehicle, which is identified on the basis of the vehicle information, is a general vehicle and congestion in the general lane is equal to or greater than reference congestion, transmitting the entry permission signal to the vehicle.

18. The method of claim 1, further comprising:
receiving vehicle information from a vehicle which is driving in the charging lane; and
when a type of the vehicle, which is identified on the basis of the vehicle information, is an electric vehicle and the congestion in the charging lane is equal to or greater than reference congestion, transmitting an exit request signal to the vehicle of which the battery power level, which is identified on the basis of the vehicle information, is equal to or greater than a reference battery power level.

19. The method of claim 1, further comprising:
receiving the vehicle information from the vehicle which is driving in the general lane; and
when a type of the vehicle, which is identified on the basis of the vehicle information, is an electric vehicle and congestion in the charging lane is less than reference congestion, transmitting an entry guide signal to the vehicle.

20. The method of claim 1, further comprising:
receiving vehicle information from a vehicle which is driving in the charging lane;
identifying a type and a charging state of the vehicle on the basis of the vehicle information; and
when the type of the vehicle is an electric vehicle and the charging state is an inactive state, transmitting a charging guide signal to the vehicle.
